(19) United States
(12) Patent Application Publication
(10) Pub. No.: US 2005/0140783 A1
(43) Pub. Date: Jun. 30, 2005

(54) Surveillance camera and surveillance camera system

(75) Inventor: Kenji Akamatsu, Daito-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: FUNAI ELECTRIC CO., LTD., Daito-shi (JP)

(21) Appl. No.: 11/013,318

(22) Filed: Dec. 17, 2004

(30) Foreign Application Priority Data
Dec. 25, 2003 (JP) 2003-430884

(51) Int. Cl. H04N 7/18

(52) U.S. Cl. 348/143; 348/164; 348/113

(57) ABSTRACT

A surveillance camera that transmits image data to a remote surveillance apparatus has an image capturing portion, an infrared receiver for receiving infrared signals from an infrared beacon disposed in each room, a GPS receiver for receiving GPS signals from a satellite positioning system, a picture combining portion for combining current position data contained in the infrared signal or the GPS signal with pictures obtained by the image capturing portion, a transmitter for transmitting combined signal of the current position data and image data to the surveillance apparatus, a memory for storing the optimal orientation data for the surveillance camera placed in a predetermined position, and a light-emitting unit for emitting light when the surveillance camera has the optimal orientation. The surveillance camera identifies the optimal orientation when the installation position of the surveillance camera is moved between different rooms.

### BACKGROUND OF THE INVENTION

1. Field of the Invention

The present invention relates to a surveillance camera. More particularly, the present invention relates to a surveillance camera for transmitting image data to a remote surveillance apparatus. Also, the present invention relates to a surveillance camera system having such surveillance camera and such remote surveillance apparatus, in which image data taken with the surveillance camera is transmitted to the remote surveillance apparatus.

2. Background Information

Japanese Laid-Open Patent Application No. 10-285585 discloses a surveillance camera that is to be disposed outdoors, wherein the installation position of the surveillance camera is identified by using a GPS (Global Positioning System) signal transmitted from a satellite, and the installation position is output as position data together with pictures. When pictures and position data are received by a remote surveillance camera apparatus, the picture signal and position data are separated, an icon screen showing the orientation of the surveillance camera is created, and the picture, map information, and surveillance camera information are output to the monitor.

With this surveillance camera, map information indicating the installation position of each camera can be viewed together with the pictures. Therefore, when monitoring pictures from a plurality of surveillance cameras, it is easy to identify which picture corresponds to which location.

With the surveillance camera apparatus of Japanese Laid-Open Patent Application No. 10-285585, the position data representing the installation position is received using GPS signals when the surveillance cameras are installed outdoors. When the surveillance cameras need to be installed indoors, however, a GPS signal cannot be received. Therefore, the installation position cannot be identified using a GPS signal. For instance, when the surveillance camera is moved from one indoor room to another it is impossible to identify the room in which the surveillance camera is installed, since a GPS signal cannot be received by the surveillance camera.

It is possible to consider providing a Bluetooth or wireless LAN access point in each room and installing a Bluetooth or LAN terminal in the surveillance camera in order to allow the installation position of the surveillance camera to be identified. However, since the radio waves pass through the walls between rooms, the electric field strength varies depending on various factors such as the wall materials. Thus, it is difficult to accurately identify the installation position of the surveillance camera. Also, when it is necessary to distinguish between rooms on different floors, it is even more difficult to determine the installation position.

In view of the above, it will be apparent to those skilled in the art from this disclosure that there exists a need for an improved surveillance camera system that overcomes the problems of the conventional art. This invention addresses this need in the art as well as other needs, which will become apparent to those skilled in the art from this disclosure.

### SUMMARY OF THE INVENTION

An object of the present invention is to provide a surveillance camera that automatically identifies the optimal orientation when the installation position of the surveillance camera is moved between rooms indoors.

The surveillance camera according to the first aspect of the present invention is configured to receive an infrared signal from an infrared beacon and transmit image data to a remote surveillance apparatus. The surveillance camera includes an image capturing portion configured to capture image and create image data; an infrared receiver configured to receive an infrared signal containing current position data from the infrared beacon; a picture combining portion configured to combine the current position data contained in the infrared signal with the image data created by the image capturing portion; and a transmitter configured to transmit the combined data of the image data and the current position data to the surveillance apparatus.

With this surveillance camera, the infrared light transmitted from the infrared beacon disposed in each room does not pass through walls between rooms, but the surveillance camera can receive an infrared signal only from the infrared beacon disposed in the room in which the surveillance camera is disposed. Accordingly, it is possible to obtain accurate position data (in other words, the room in which the surveillance camera is disposed). The current position data is combined with the picture and is outputted, so image data containing the position data can be displayed on the surveillance apparatus.

In the surveillance camera according to the second aspect of the present invention, the surveillance camera according to the first aspect of the present invention, and further has a memory configured to store at least one optimal orientation data, the optimal orientation data corresponding to predetermined position data; an orientation sensor configured to obtain current orientation data of the surveillance camera; a control portion operatively coupled to the memory, the orientation sensor, and the infrared receiver and configured to retrieve from the memory the optimal orientation data that corresponds to the current position data and compare the current orientation data with the retrieved optimal orientation data; and an indicator unit operatively coupled to the control portion and configured to indicate whether the current orientation of the surveillance camera is the optimal orientation.

When the surveillance camera is to be installed in a predetermined installation position, the user can be informed that the surveillance camera is in an optimal orientation in the predetermined installation position. In other words, when the surveillance camera is installed in the optimal position and orientation for obtaining the best view, the user is notified of it through the indicator that, for instance, emits light. Thus, the user does not check the screen on the surveillance apparatus to adjust the orientation of the surveillance camera, and the surveillance camera can be easily disposed in the position and orientation that enable the best view in the room.

In the surveillance camera according to the third aspect of the present invention, the surveillance camera according to the first aspect of the present invention wherein the control portion is further configured to assume a security mode, and control the transmitter to transmit a theft notification signal to the surveillance apparatus if the current position changes or the infrared receiver fails to receive an infrared signal from the infrared beacon while the security mode is assumed.

With this surveillance camera, the infrared signal for transmitting current position data is used to enable a theft prevention procedure, which allows a theft signal to be transmitted to the surveillance apparatus as a theft prevention alarm. Therefore, a theft prevention function can be easily included.

In the surveillance camera according to the fourth aspect of the present invention, the surveillance camera according to any of the first through third aspects of the present invention further has a GPS receiver configured to receive a GPS signal containing current position data from a satellite positioning system. The picture combining portion is configured to combine the current position data contained in the infrared signal or the GPS signal with the image data obtained by the image capturing portion.

With this surveillance camera, the installation position (the room in which a surveillance camera is disposed) can be identified by an infrared signal from an infrared beacon when the surveillance camera is installed indoors, and the installation position can be identified with a GPS signal when the surveillance camera is disposed outdoors.

In the surveillance camera according to the fifth aspect of the present invention, the theft signal transmission device in the surveillance camera according to the fourth aspect of the present invention, wherein the control portion is further configured to assume a security mode, and control the transmitter to transmit a theft notification signal to the surveillance apparatus if the current position changes while the security mode is assumed.

With this surveillance camera, the GPS signal for transmitting current position data is used to enable a theft signal to be transmitted to the surveillance apparatus as a theft prevention alarm. Therefore, a theft prevention function can be easily included.

The surveillance camera system according to the sixth aspect of the present invention has a plurality of infrared beacons adapted to be disposed in different rooms and configured to send an infrared signal; a surveillance camera; and a surveillance apparatus configured to receive the combined data of the image data and the current position data from the surveillance camera. The surveillance camera includes an image capturing portion configured to capture image and create image data, an infrared receiver configured to receive the infrared signal from the infrared beacon, the infrared signal containing current position data of the surveillance camera, a picture combining portion configured to combine the position data contained in the infrared signal with the image data created by the image capturing portion, and a transmitter configured to transmit the combined data of the image data and the current position data to the surveillance apparatus.

With this surveillance camera, since the infrared light transmitted from the infrared beacons disposed in different rooms does not pass through walls between the rooms, the surveillance camera can receive infrared signals solely from the infrared beacon that is disposed in the room in which the surveillance camera is installed. Therefore, accurate current position data (the room in which the surveillance camera is disposed) can be obtained. The current position data is combined with the picture and is outputted. Therefore, an image data containing the position data can be displayed on the surveillance apparatus.

In the surveillance camera system according to the seventh aspect of the present invention, the theft signal transmission device in the surveillance camera system according to the sixth aspect of the present invention, wherein the infrared receiver is further configured to send a position data request signal to the infrared beacon to request the infrared signal containing the current position data.

The surveillance camera according to the eighth aspect of the present invention has image capturing means for capturing image and creating image data; infrared receiving means for receiving an infrared signal from the infrared beacon, the infrared signal containing current position data of the surveillance camera; GPS receiving means for receiving a GPS signal from the satellite positioning system, the GPS signal containing current position data of the surveillance camera; picture combining means for combining position data contained in the infrared signal or the GPS signal with the imaged data created by the image capturing means; transmitting means for transmitting the combined data of the image data and the current position data to the surveillance apparatus; memory means for storing at least one optimal orientation data, the optimal orientation data corresponding to predetermined position data; an orientation sensor configured to obtain current orientation data of the surveillance camera; control means for retrieving the optimal orientation data that corresponds to the current position data and comparing the current orientation data with the retrieved optimal orientation data; and a light-emitting indicator unit operatively coupled to the control means and configured to indicate whether the current orientation of the surveillance camera is the optimal orientation by emitting light.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic structural diagram of the surveillance camera system according to an embodiment of the present invention;

FIG. 2 is a schematic structural diagram of an infrared beacon in accordance with the embodiment of the present invention;

FIG. 3 is a schematic structural diagram of a surveillance camera in accordance with the embodiment of the present invention;

FIG. 4 is a schematic structural diagram of a surveillance apparatus in accordance with the embodiment of the present invention;

FIG. 5 is a schematic diagram describing imaging by a surveillance camera in a child's room in accordance with the embodiment of the present invention;

FIG. 6 is an example of an image screen shown at the surveillance apparatus in accordance with the embodiment of the present invention;

FIG. 7 is a flowchart of the position data receiving routine in accordance with the embodiment of the present invention;

FIG. 8 is a flowchart of the orientation data receiving routine in accordance with the embodiment of the present invention;

FIG. 9 is a flowchart of the imaging capturing routine in accordance with the embodiment of the present invention; and

FIG. 10 is an example of data configuration for optimal orientation of the surveillance camera in accordance with the embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

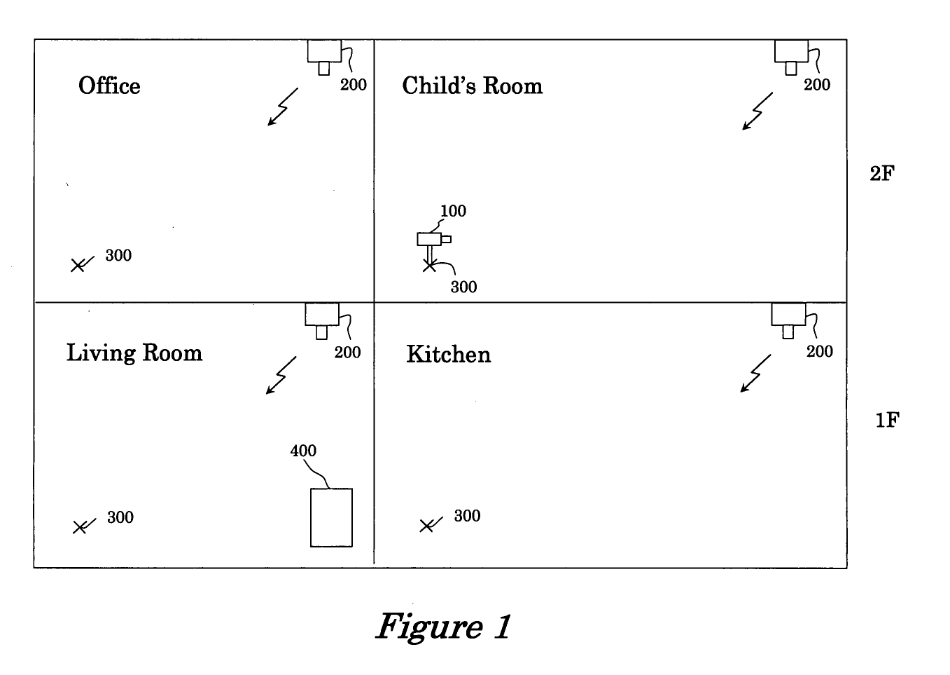

FIG. 1 is a schematic structural diagram of the surveillance camera system according to an embodiment of the present invention. The surveillance camera system has a plurality of infrared beacons 200, a surveillance camera 100 that obtains position data from the infrared beacon 200 and captures images to create picture signals, and a surveillance apparatus 400 for receiving picture signals combined with position data from the surveillance camera 100.

As shown in FIG. 1, one infrared beacon 200 is installed in each room, such as a child's room, the kitchen, office, and the living room. The installation position 300, at which a surveillance camera 100 is to be installed, is preconfigured for each room. However, if there is no need to predetermine the best—position and orientation, which will be described below, in any particular room, there is no need to pre-configure the installation position 300 for that room.

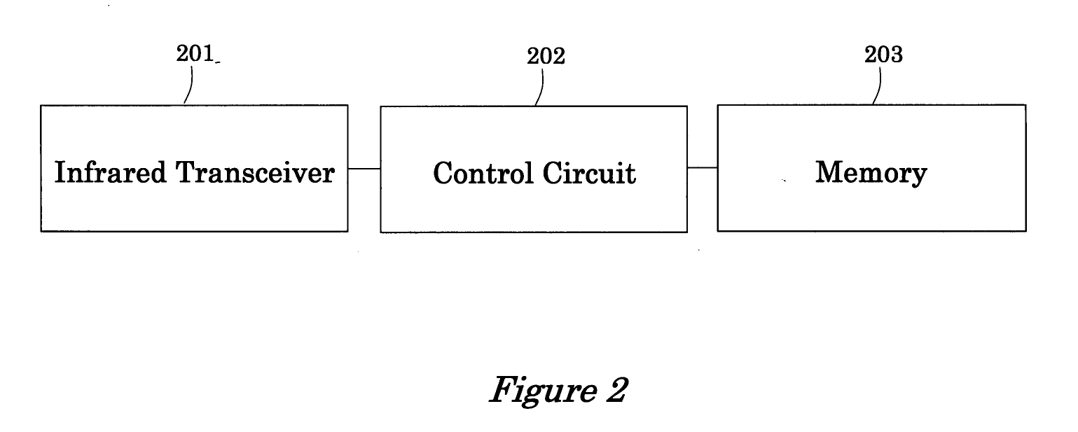

As seen in FIG. 2, each of the infrared beacon 200 has an infrared transceiver unit 201, a control circuit 202, and a memory 203, as shown in FIG. 2. When the infrared beacon 200 receives a transmit request signal from the surveillance camera 100, the infrared beacon 200 transmits the position data to the surveillance camera 100. Position data such as the name of the room (child's room, kitchen, office, living room) in which the infrared beacon 200 is placed is stored in the memory 203 of the infrared beacon 200 in a text format. The control circuit 202 is operatively coupled to the infrared transceiver 201 and the memory 203, such that the control circuit 202 can selectively control and access any of the components of the infrared beacon 200. The infrared transceiver unit 201 transmits and receives infrared signals from the surveillance camera 100. When the infrared transceiver unit 201 receives an infrared signal containing a transmit request from the surveillance camera 100, the transmit request is sent to the control circuit 202. When the control circuit 202 receives a transmit request from the infrared transceiver unit 201, the control circuit 202 reads the position data from the memory 203 and send the current position data to the infrared transceiver unit 201. When the position data from the control circuit 202 is received, the infrared transceiver unit 201 creates an infrared signal that contains the current position data and sends the infrared signal to the surveillance camera 100.

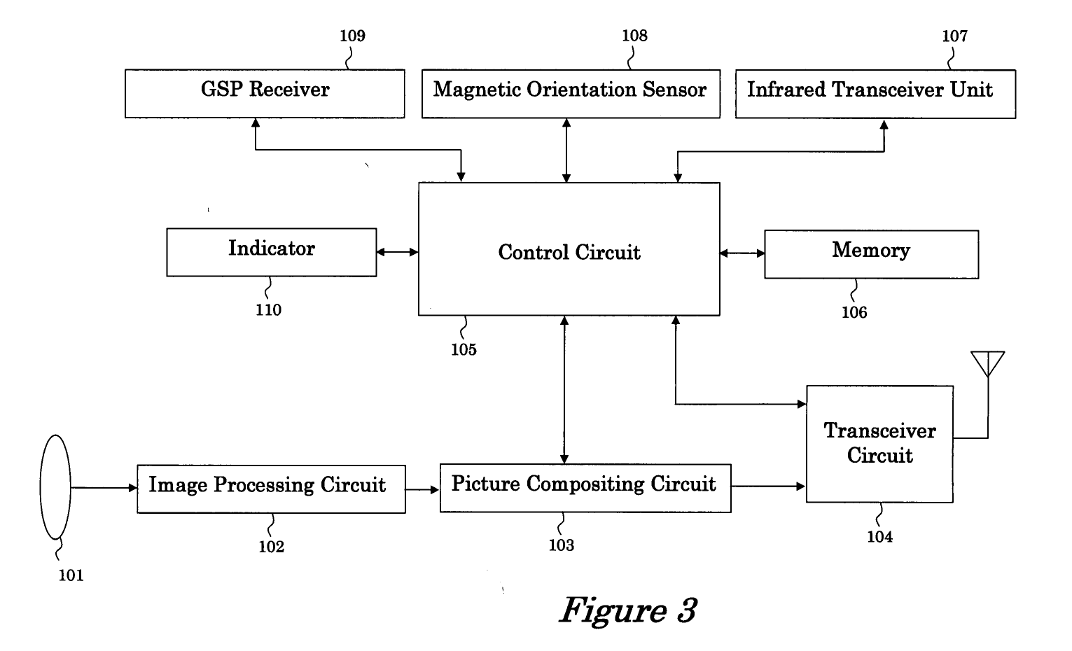

Referring to FIG. 3, the surveillance camera 100 has an imaging lens 101 (an example of the image capturing portion), an image processing circuit 102, a picture combining circuit 103, a transceiver circuit 104, a control circuit 105, a memory 106, an infrared transceiver unit 107, a magnetic orientation sensor 108, and a GPS receiver 109. The control circuit 105 is operatively coupled to the various components of the surveillance camera 100 so as to be able to selectively control and access any of these components.

The image processing circuit 102 generates a picture signal from the picture captured through the image lens 101. For instance, the image processing circuit 102 converts the picture into an electric signal (picture signal) by using a CCD (Charge-Coupled Device) or another imaging element, for example. The picture combining circuit 103 combines the picture signal outputted from the image processing circuit 102 and the position data outputted from the control circuit 105, and creates a combined signal that combines the picture signal with the position data. The transceiver circuit 104 transmits the combined signal to the surveillance apparatus 400. The transmission from the transceiver circuit 104 to the surveillance apparatus 400 can be based on a wireless LAN, a wireless telephone line or other known wireless radio wave, or based on a wired or wireless local area network (Ethernet (IEEE 802.3), for example). Although the position data is combined with the picture signal and sent to the surveillance apparatus 400 here, the position data can be sent to the surveillance apparatus 400 separately from the picture signal and combined with the picture signal at the surveillance apparatus 400.

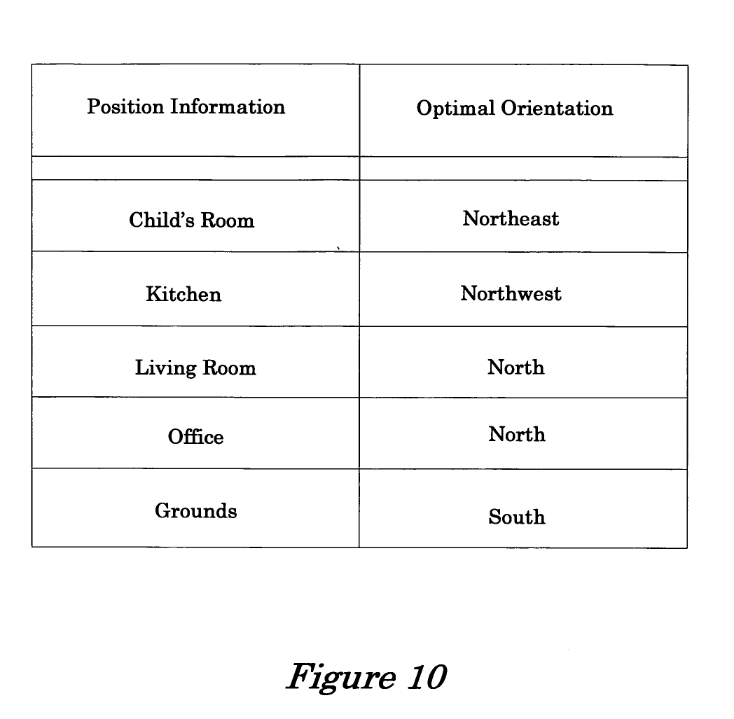

The memory 106 stores the current position data obtained through the control circuit 105, as well as the optimal orientation of the surveillance camera 100 for each room, which is the orientation in which the picture can be best obtained (best shot picture) when the surveillance camera 100 is placed at the installation position 300. The optimal orientation is preconfigured for each indoor room, as shown in FIG. 10. The user sets the optimal orientation of the surveillance camera 100 in each room in advance. Also, when the surveillance camera 100 is to be placed outdoors and the position at which the surveillance camera 100 is to be placed is already known, the user pre-configures the optimal orientation at the outdoor installation position and stores the optimal orientation in the memory 106 so as to be associated with the outdoor installation position.

The infrared transceiver unit 107 transmits and receives infrared signals to and from the infrared beacon 200. The infrared transceiver unit 107 transmits to the infrared beacon 200 a position data transmit request sent from the control circuit 105, receives an infrared signal that contains position data from the infrared beacon 200, and transmits the position data to the control circuit 105.

The magnetic orientation sensor 108 detects the orientation of the main body of the surveillance camera 100, creates orientation data, and outputs the detected orientation data to the control circuit 105. The GPS receiver 109 receives a GPS signal from the satellite positioning system (GPS) and transmits the detected GPS signal to the control circuit 105. An indicator 110 is provided on the outside wall of the main body of the surveillance camera 100, and is lighted in response to the signal sent from the control circuit 105.

The control circuit 105 sends a position data transmit request at predetermined time intervals to the infrared transceiver unit 107 and the GPS receiver 109, and obtains the position data by receiving an infrared signal or a GPS signal. The position data contained in the infrared signal is location information in text format that indicates the name of each room, and the position data contained in the GPS signal is the latitude, longitude, and altitude of the installation position of the surveillance camera 100.

The control circuit 105 outputs to the picture combining circuit 103 the position data contained in the infrared signal or the GPS signal and the current orientation data of the surveillance camera 100 obtained from the magnetic orientation sensor 108. In the picture combining circuit 103, the position data and the orientation data are combined with the picture signal output from the image processing circuit 102, and the combined picture signal in which the position data and orientation are combined is transmitted to the surveillance apparatus 400 through the transceiver circuit 104.

The control circuit 105 retrieves from the memory 106 the optimal orientation of the surveillance camera 100 that corresponds to the position data contained in the infrared signal or GPS signal, and determines whether the current orientation of the surveillance camera 100 obtained from the magnetic orientation sensor 108 matches the optimal orientation. The control circuit 105 outputs a light-up signal to the indicator 110 when the current orientation matches the optimal orientation, and the indicator 110 lights up.

Also, the control circuit 105 receives a configuration for a security mode, by which the movement of the surveillance camera 100 is restricted. When the surveillance camera 100 is moved while the security mode is activated, the control circuit 105 transmits a theft signal to the surveillance apparatus 400, indicating that the surveillance camera 100 is being stolen. Such theft signal is transmitted particularly when the surveillance camera 100 is moved out of the area of the infrared signal reception and reception of the infrared signal is cut off, when the position data contained in the infrared signal has changed to indicate that the surveillance camera 100 is in another room; when the GPS signal is dropped because of the surveillance camera 100 moving out of the GPS reception area, or when the position data contained in the GPS signal has changed.

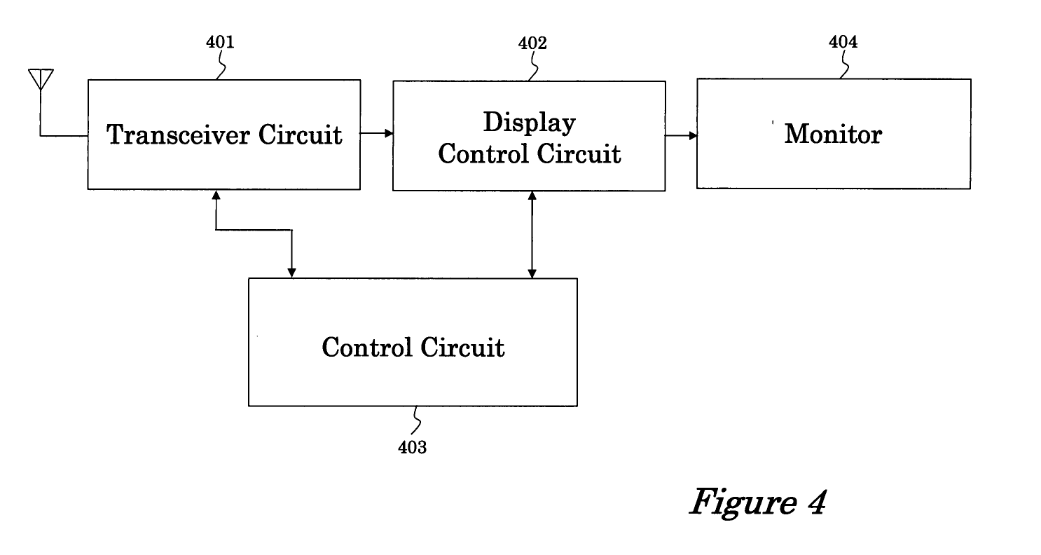

Referring to FIG. 4, the surveillance apparatus 400 is installed in the same house or building in which the surveillance camera 100 is located, or outside the house or building. The surveillance apparatus 400 has a transceiver circuit 401, a display control circuit 402, a control circuit 403, and a monitor 404. The control circuit 403 is operatively coupled to the transceiver circuit 401 and the display control circuit 402 so as to be able to selectively control and access any of the components in the surveillance apparatus 400. The transceiver circuit 401 transmits and receives data from the surveillance camera 100 through a wireless telephone line or another wireless channel, or a wired or wireless local area network (Ethernet, for example). When the display control circuit 402 receives a combined picture signal that includes the position data and the orientation data in the transceiver circuit 401, the combined picture signal is processed and outputted to the monitor 404. The control circuit 403 controls the transceiver circuit 401 and the display control circuit 402.

Operation

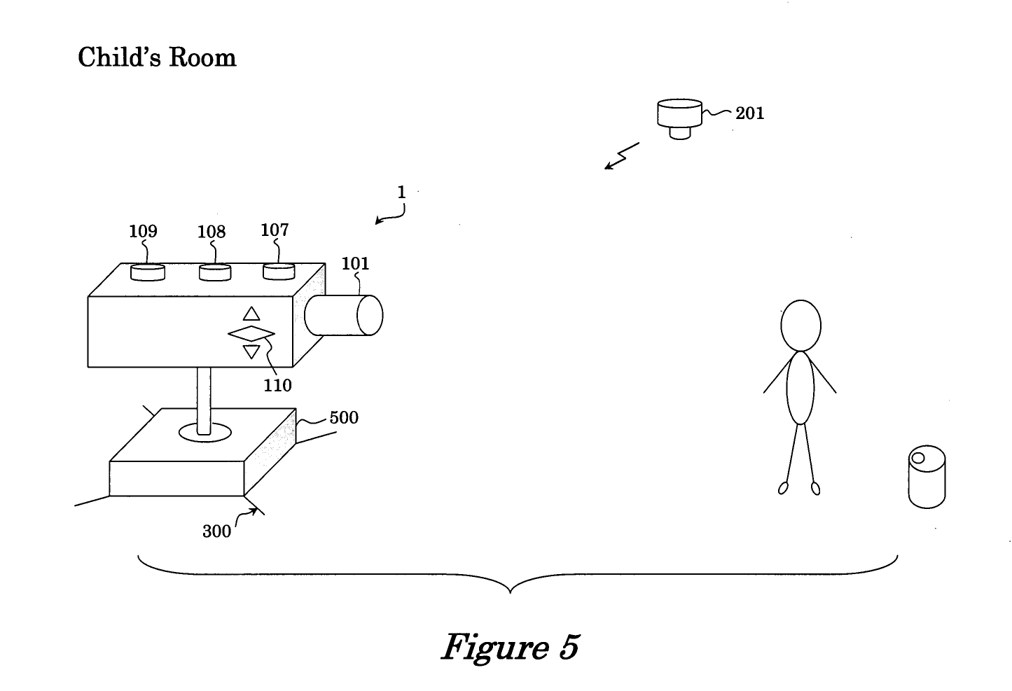

FIG. 5 is a schematic diagram depicting the image-capturing by a surveillance camera 100 in a child's room. When the user places the surveillance camera 100 in a predetermined installation position 300 with an installation pedestal 500 and turns on the surveillance camera 100, the surveillance camera 100 sends a position data transmit request to the infrared beacon 200 and obtains position data from the infrared beacon 200. When the position data is obtained, the optimal orientation of the surveillance camera 100 that corresponds to the position data is retrieved from the internal memory 106 of the surveillance camera 100. Here, the optimal orientation is the orientation (for instance, northeast for child's room, in the case of the example shown in FIG. 10) of the surveillance that allows the surveillance 100 to best capture the picture of the room. Then, the orientation of the main body of the surveillance camera 100 is compared with the optimal orientation (northeast). Accordingly, the user adjusts the orientation of the surveillance camera 100. When the orientation of the main body of the surveillance camera 100 matches the optimal orientation, the indicator 110 lights up, and the user fixedly installs surveillance camera 100 so as to assume the optimal orientation.

The installation pedestal 500 is fixedly installed at the installation position 300 in each room in advance, such that the surveillance camera 100 can be fixedly installed on the installation position 300 by merely coupling the surveillance camera 100 to the installation pedestal 500.

In this manner, when the image capturing is started by the surveillance camera 100, the best view of the child's room is obtained by the lens 101 and the image processing circuit 102. Also, the position data obtained from the infrared beacon 200 and the orientation data from the magnetic orientation sensor 108 are combined with the picture signal and transmitted to the surveillance apparatus 400.

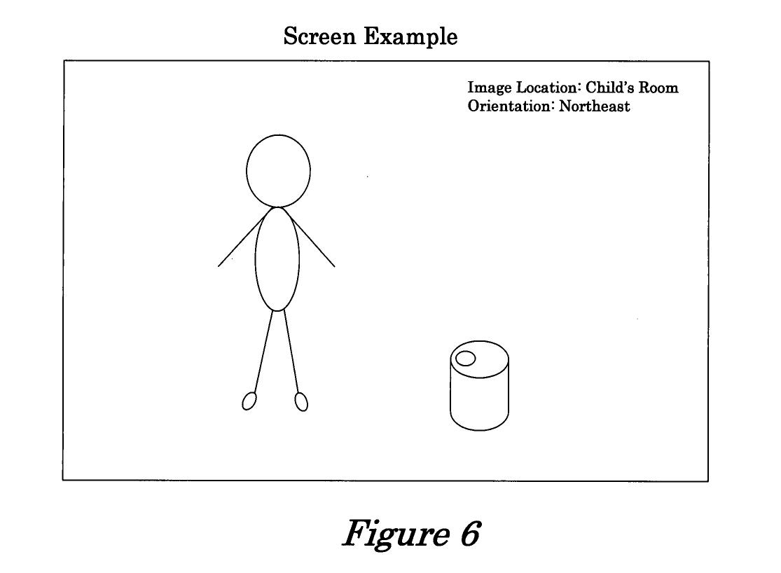

When the surveillance apparatus 400 receives the combined picture signal including the position data, the surveillance apparatus 400 displays a screen such as the one in FIG. 6 on the monitor 404. The position data “Image location: Childs' room” and the orientation data “Orientation: Northeast” are displayed on the screen along with the image captured by the lens 101 and the image processing circuit 102.

When the surveillance camera 100 is thereafter moved to the kitchen and fixedly installed at the installation position while assuming the optimal orientation, the surveillance camera 100 receives the position data from the infrared beacon 200 located in the kitchen, obtains the new orientation data from the magnetic orientation sensor 108, combines the position data and the orientation with the picture signal, and transmits the combined picture signal to the surveillance apparatus 400. The position data “Image location: Kitchen” and the orientation data “Orientation: Northwest” (in the example shown in FIG. 10) are displayed together with the best viewed image of the kitchen on the monitor 404 of the surveillance apparatus 400.

On the other hand, when the surveillance camera 100 is disposed outdoors, a GPS signal is received from the satellite positioning system, the position data (latitude, longitude, and altitude) is obtained, the orientation data is received from the magnetic orientation sensor 108. The orientation data and the position data (latitude, longitude, and altitude) are combined with the picture signal and transmitted to the surveillance apparatus 400.

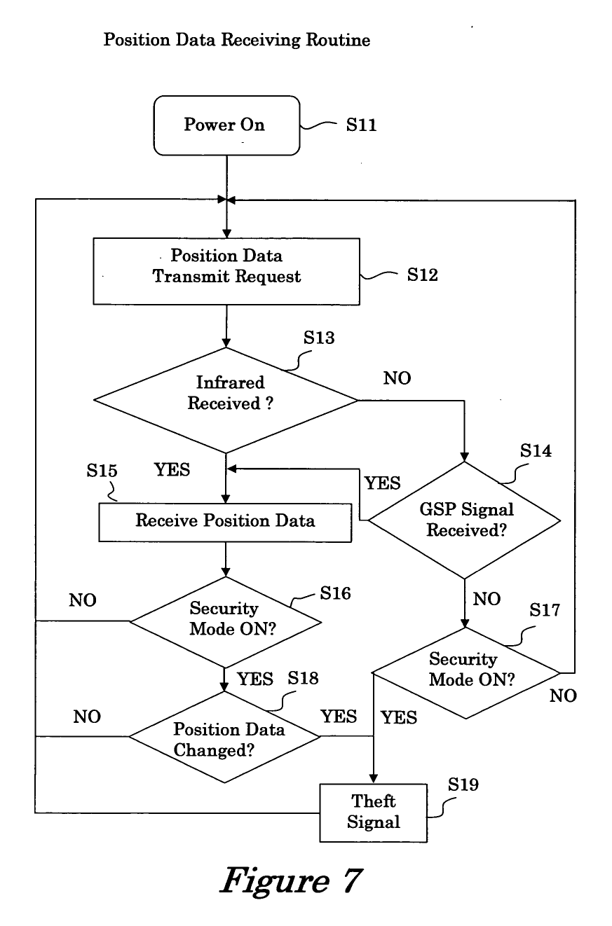

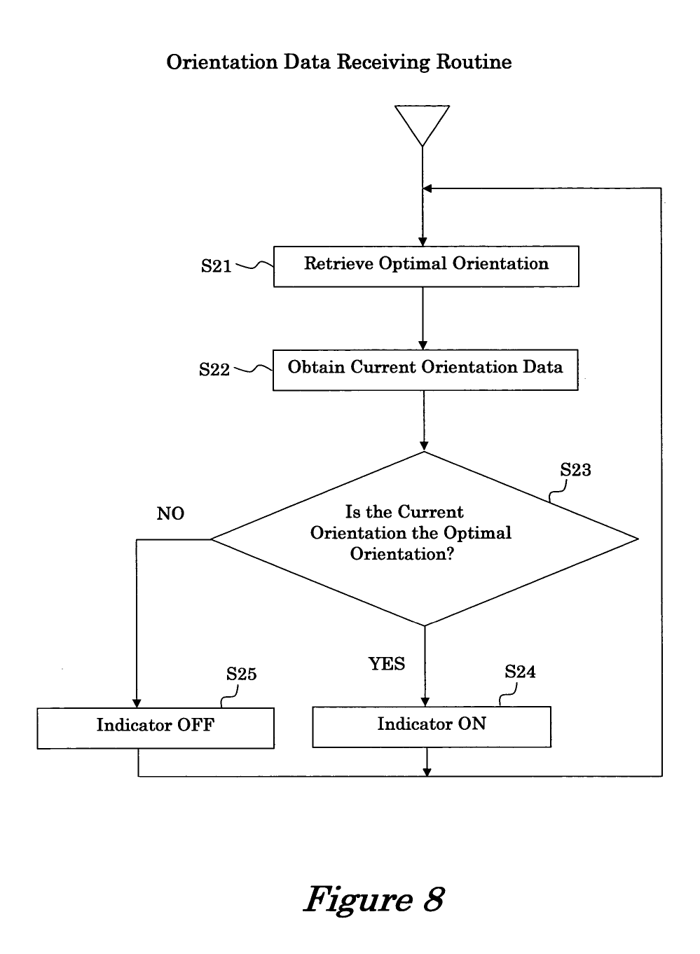

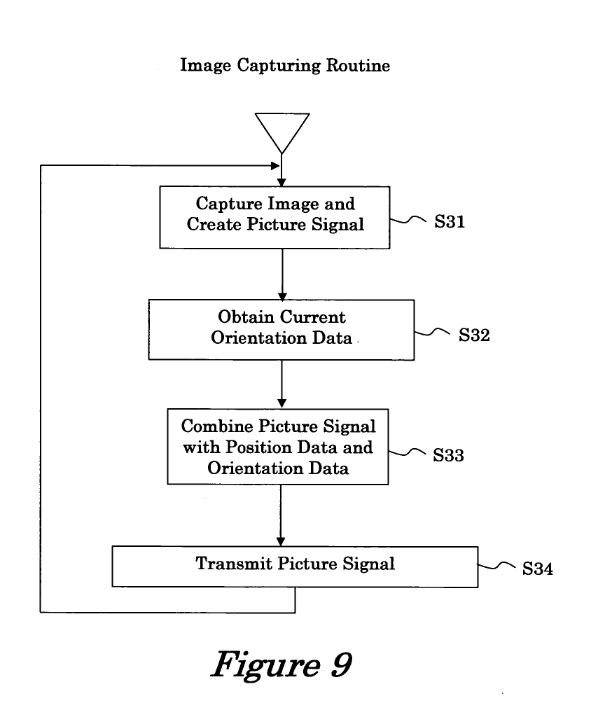

Referring to FIGS. 7-9, various routines of the surveillance camera 100 will now be explained. The control circuit 105 of the surveillance camera 100 performs the position data receiving routine shown in FIG. 7 every predetermined period of time. The duration of the predetermined period time can be, for instance, shorter than one minute, or longer than several minutes. The surveillance camera 100 obtains its current position data through the position data receiving routine. An orientation data receiving routine shown in FIG. 8 and an image capturing routine shown in FIG. 9 are concurrently performed after the position data receiving routine, also every predetermined period of time, using the current position data obtained in the position data receiving routine.

Position Data Receiving Routine

The position data receiving routine in the surveillance camera 100 is described below with reference to FIG. 7. In the example of the position data receiving routine shown in FIG. 7, the surveillance camera 100 also performs the theft prevention function. When the surveillance camera 100 is fixedly coupled to the installation pedestal 500 on the installation position 300 of the child's room, for example, the processes in steps S12 to S19 are repeated every predetermined period of time. In step S12, the position data transmit request is transmitted from the surveillance camera 100 to the infrared beacon 200. Then, the control circuit 105 determines whether an infrared signal has been received in step S13. If an infrared signal has been received, the position data is obtained in step S15 from the infrared signal received from the infrared beacon 200. When, on the other hand, an infrared signal is not received in step S13, the control circuit 105 determines whether a GPS signal has been received in step S14. If a GPS signal has been received, the position data is obtained from the GPS signal in step S115.

In the following steps S16-S19, the circuit control 105 performs the theft prevention function by determining whether the surveillance camera 100 has been moved to a different position or to outside the signal reception area of the infrared beacon 200 or the GPS satellite. In step S16, it is determined if the security mode is on. If it is on, the circuit control 105 determines in step S18 whether the current position data has changed since the last-obtained position data. If the current position data did change, the circuit control 105 proceeds to step S19 and transmits a theft signal to the surveillance apparatus 400. If the security mode is not on in step S15 or if the current position data did not change in step S18, then the circuit control 105 returns to step S12, and transmits a position data transmit request to the infrared beacon 200 after the predetermined period of time has passed since the last position data transmit request.

If a GPS signal is not received in step S14, the circuit control 105 proceeds to step S17, and determines whether the security mode is on. If the security mode is on, the circuit control 105 proceeds to step S19 and transmits the theft signal to the surveillance apparatus 400. If the security mode is not on in step S17, then the circuit control 105 returns to step S12, and transmits a position data transmit request to the infrared beacon 200 after the predetermined period of time has passed since the last position data transmit request.

The steps S12 to S19 described above are repeated every predetermined period of time. The most recent position data is used for the orienting data receiving routine and the image capturing routine described above.

Here, a transmit request is sent from the surveillance camera 100 to the infrared beacon 200 and the GPS satellite every predetermined period of time to obtain the position data. However, if the infrared beacon 200 or the GPS satellite is configured to transmit the position data every predetermined period of time, the surveillance camera 100 does not need to send a transmit request to the infrared beacon 200.

Orientation Data Receiving Routine

The orientation data receiving routine by which the indicator 110 emits light is described below with reference to FIG. 8. In this routine, the steps S21 to S25 described below are repeated every predetermined period of time, after the position data receiving routine described above. In step S21, the optimal orientation (for example northeast, which is the orientation of the best view of the child's room), which corresponds to the position data that was obtained during the position data receiving routine, is retrieved from the memory 106. In step S22, the current orientation data of the surveillance camera 100 is obtained from the magnetic orientation sensor 108. Then, in step S23, the control circuit 105 determines whether the current orientation matches the optimal orientation. If the current orientation does not match the optimal orientation, the indicator 110 remains OFF (step S25), and the control circuit 105 returns to step S21. In other words, when the current orientation is not the optimal orientation, the indicator 110 is switched off if it is on, and if the indicator 110 is already off, the indicator 110 remains off. On the other hand, when the current orientation is the optimal orientation, the indicator 110 is switched on if it is off, and if the indicator 110 is on it is kept on. Then, the control circuit 105 returns to step S21.

Image Capturing Routine

Concurrently with the orientation data receiving routine shown in FIG. 8, the control circuit 105 of the surveillance camera 100 performs an image capturing routine described below and shown in FIG. 9. In step S31, the surveillance camera 100 starts capturing images and creates a picture signal. Then, the current orientation data is obtained from magnetic orientation sensor 108 in step S32. Thereafter, using the current position data that has been obtained in the position data receiving routine, the control circuit 105 in step S33 combines with the picture signal the current position data and the current orientation data. Then, the combined picture signal that includes the current position data and the current orientation data is transmitted to the surveillance apparatus 400 in step S34. In the surveillance apparatus 400, the combined picture signal is displayed on the monitor 404.

When the surveillance camera 100 is situated indoors in accordance with the present invention, the infrared signal transmitted from the infrared beacon 200 disposed in each room does not pass through walls and reach other rooms. Thus, only the infrared signal from the infrared beacon 200 disposed in the room can be received by the surveillance camera 100. Therefore, accurate position data of the room in which the surveillance camera is disposed can be obtained. When, on the other hand, the surveillance camera 100 is disposed outdoors, accurate position data can be obtained from the GPS signal. Also, the position data is outputted after being combined with the picture and. Therefore, a picture containing the position data can be displayed at the surveillance apparatus 400.

Also, when the surveillance camera 100 is placed in the installation position that is preconfigured for each room, or the outdoor installation position 300 that is preconfigured in an outdoor area, the user can ascertain that the surveillance camera 100 is disposed in the optimal position and orientation for the best view, by referring to the indicator 110 that indicates whether the surveillance camera 100 is positioned in the optimal orientation at the installation position 300. Therefore, the user does not have to check the monitor of the surveillance apparatus 400 when he adjusts the position and the orientation of the surveillance camera 100 to ensure that the surveillance camera 100 has the best view. Thus, the surveillance camera 100 can be easily disposed in the position and orientation that provide the best view.

Also in this embodiment, a theft signal is transmitted as a theft prevention alarm using the infrared signal or GPS signal for transmitting position data. Therefore, a theft prevention function can be easily performed.

### Other Embodiments

In the above described embodiments, the name of each room is sent in a text format from the infrared beacon 200 to the surveillance camera 100, but it is also possible to employ an arrangement in which the latitude, longitude, and altitude of each room are stored in the infrared beacon 200 in a text format in advance. In that case; the latitude, longitude, and altitude of each room, instead of the name of the room, are combined with the picture signal by the surveillance camera 100; and the latitude, longitude, and altitude of each room are displayed on the monitor 404 of the surveillance apparatus 400 as the image location. Also, the latitude, longitude, and altitude of each room may be associated with the text data of the name of the room and stored in the surveillance camera 100 in advance; such that the latitude, longitude, and altitude of each room can be converted to the name of each room and combined with the picture signal. In this case, the name of the room is displayed on the monitor 404 of the surveillance apparatus 400 as the image location in the same manner as in the above-described embodiment.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

In accordance with the present invention, a surveillance camera that automatically obtains an installation position can be provided even when the surveillance camera is moved between indoor rooms.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2003-430884. The entire disclosure of Japanese Patent Application No. 2003-430884 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A surveillance camera configured to receive an infrared signal from an infrared beacon and transmit image data to a remote surveillance apparatus, comprising:
an image capturing portion configured to capture image and create image data;
an infrared receiver configured to receive an infrared signal containing current position data from the infrared beacon;
a picture combining portion configured to combine the current position data contained in the infrared signal with the image data created by the image capturing portion; and
a transmitter configured to transmit the combined data of the image data and the current position data to the surveillance apparatus.

2. The surveillance camera according to claim 1, further comprising
a memory configured to store at least one optimal orientation data, the optimal orientation data corresponding to predetermined position data;
an orientation sensor configured to obtain current orientation data of the surveillance camera;
a control portion operatively coupled to the memory, the orientation sensor, and the infrared receiver and configured to retrieve from the memory the optimal orientation data that corresponds to the current position data and compare the current orientation data with the retrieved optimal orientation data; and
an indicator unit operatively coupled to the control portion and configured to indicate whether the current orientation of the surveillance camera is the optimal orientation.

3. The surveillance camera according to claim 1, wherein
the control portion is further configured to assume a security mode, and control the transmitter to transmit a theft notification signal to the surveillance apparatus if the current position changes or the infrared receiver fails to receive an infrared signal from the infrared beacon while the security mode is assumed.

4. The surveillance camera according to claim 1, further comprising
a GPS receiver configured to receive a GPS signal containing current position data from a satellite positioning system,
the picture combining portion being configured to combine the current position data contained in the infrared signal or the GPS signal with the image data obtained by the image capturing portion.

5. The surveillance camera according to claim 4, wherein
the control portion is further configured to assume a security mode, and control the transmitter to transmit a theft notification signal to the surveillance apparatus if the current position changes while the security mode is assumed.

6. A surveillance camera system comprising
a plurality of infrared beacons adapted to be disposed in different rooms and configured to send an infrared signal;
a surveillance camera, including
an image capturing portion configured to capture image and create image data,
an infrared receiver configured to receive the infrared signal from the infrared beacon, the infrared signal containing current position data of the surveillance camera,
a picture combining portion configured to combine the position data contained in the infrared signal with the image data created by the image capturing portion, and
a transmitter configured to transmit the combined data of the image data and the current position data to the surveillance apparatus; and
a surveillance apparatus configured to receive the combined data of the image data and the current position data from the surveillance camera.

7. The surveillance camera system according to claim 6, wherein
the infrared receiver is further configured to send a position data request signal to the infrared beacon to request the infrared signal containing the current position data.

8. A surveillance camera configured to receive a signal from an infrared beacon and a satellite positioning system and transmit image data to a remote surveillance apparatus, comprising:
image capturing means for capturing image and creating image data;
infrared receiving means for receiving an infrared signal from the infrared beacon, the infrared signal containing current position data of the surveillance camera;
GPS receiving means for receiving a GPS signal from the satellite positioning system, the GPS signal containing current position data of the surveillance camera;
picture combining means for combining position data contained in the infrared signal or the GPS signal with the imaged data created by the image capturing means;
transmitting means for transmitting the combined data of the image data and the current position data to the surveillance apparatus;
memory means for storing at least one optimal orientation data, the optimal orientation data corresponding to predetermined position data;
an orientation sensor configured to obtain current orientation data of the surveillance camera;
control means for retrieving the optimal orientation data that corresponds to the current position data and comparing the current orientation data with the retrieved optimal orientation data; and
a light-emitting indicator unit operatively coupled to the control means and configured to indicate whether the current orientation of the surveillance camera is the optimal orientation by emitting light.
